(19) United States
(12) Patent Application Publication
(10) Pub. No.: US 2015/0017356 A1
(43) Pub. Date: Jan. 15, 2015

(54) PHOSPHORAMIDITE COMPOSITIONS

(71) Applicant: Thermo Fisher Scientific (Milwaukee) LLC, Milwaukee, WI (US)

(72) Inventor: Chris Joseph Oberle, Shorewood, WI (US)

(21) Appl. No.: 14/380,736

(22) PCT Filed: Feb. 26, 2013
(86) PCT No.: PCT/US13/27767

§ 371 Date: Aug. 25, 2014

Related U.S. Application Data
(60) Provisional application No. 61/603,408, filed on Feb. 27, 2012.

(51) Int. Cl. C07F 9/28; A61J 1/03

(52) U.S. Cl. CPC C07F 9/28; A61J 1/03
USPC 428/34.1; 564/12; 428/402

(57) ABSTRACT

A single-use, pre-weighed, pre-packaged solid compressed form of a phosphoramidite. In one embodiment, the single-use pre-weighed pre-packaged solid compressed phosphoramidite is packaged in individual discrete units in a package for direct dispensing into an instrument.

This application claims priority to co-pending U.S. application Ser. No. 61/603,408 filed Feb. 27, 2012 which is expressly incorporated by reference herein in its entirety.

Phosphoramidites (—(RO)₂ PNR₂) are monoamides of a phosphite diester used for synthesis of modified oligonucleotides (deoxyribonucleic acids (DNA) and ribonucleic acids (RNA)). Such modified oligonucleotides are used as primers, probes, or in structural studies. In such uses, chemical purity, and control of impurities and residual water content is crucial. Highly defined impurity profiles, limited potential for contamination during handling, batch-to-batch consistency, and strictly controlled processes (e.g., documented process control, supply chain control) is crucial.

Many phosphoramidites exist as crystalline or amorphous solids that are typically crushed or sieved to result in a powder. The phosphoramidite particle size is about 20 microns. The powder is then dispensed into final packages of known weight for the above-described synthesis.

One embodiment of the invention is a formulation comprising phosphoramidite formulated as a powder compressed into a single-use, self-contained solid in the absence of a glass vial. The formulation may contain at most 1% water or may be substantially anhydrous. The solid form may be a tablet, a pill, and/or a pellet. The density may range from about 0.1 g/cm³ to about 10 g/cm³. The ratio of surface area to weight may range from about 0.1 cm²/g to about 10 cm²/g. The phosphoramidite powder average particle size may range from about 1 μm to about 1000 μm, and in one embodiment is about 20 μm. The container may be plastic, and the formulation may be packaged with a desiccant. The container may be light-retardant itself or contain light retardant means, both known in the art. In one embodiment the solid form may have a water-retardant or water-impervious coating. Phosphoramidite purity generally ranges from about 85% to about 100%, and in one embodiment is about 98%.

One embodiment of the invention is a kit comprising at least one single-use, pre-weighed, pre-packaged solid compressed phosphoramidite, and instructions for their use, e.g., in an instrument, for a specific assay, etc. The kit may contain a plurality of single-use, pre-weighed, pre-packaged solid compressed forms of phosphoramidites.

One embodiment of the invention is phosphoramidite formulated as a powder compressed into multiple solid forms for either a single use, either full single use or a fraction thereof, or for multiple uses. Such multiple solid forms include tablets, pellets, pills, etc.

In the inventive method, the phosphoramidite powder is produced and pressed or compressed into a single-use, pre-weighed, pre-packaged phosphoramidite self-contained composition. This self-contained composition avoided the need to aliquot the pre-weighed powder into any sort of container (e.g., vials specific for a particular instrument). This self-contained composition reduced the amount of surface area of the composition was exposed to conditions such as humidity, moisture, etc. This self-contained composition provided ease of handling, weighing, shipping, packaging, storage, etc., among other benefits.

The single-use, pre-weighed, pre-packaged solid compressed form is referred to synonymously as a pill, pellet, or tablet. In one embodiment the single-use, pre-weighed, pre-packaged solid compressed form is directly dispersed into a liquid. Each pellet is uniform, and can be in any shape and/or size suitable to an end user, and/or any combinations of shapes and/or sizes suitable to an end user, for further processing, e.g., automated processing. In an automated system, it is likely that density would increase and surface area/weight would decrease due to the higher forces that a machine could deliver.

The composition is generally provided to the end user in one or more discrete units. The units may be multiple units in a single package and may be for multiple uses. In one embodiment, a plurality of substantially identical tablets are in a container. In one embodiment a plurality of non-identical tablets are in a container. Non-identical tablets can vary in, e.g., density, surface area to weight ratio, phosphoramidite particle size, etc.

The composition in discrete units is contained in a pre-sealed, user-convenient container or package from which it can be readily and easily dispensed. Such containers are not limited. As examples, in one embodiment the container is a bottle, in one embodiment the container is a bag, and in one embodiment the container is a blister-pack. The pre-sealed package provides the composition in aliquots that are accurately measured and are available for immediate use upon release with no further manipulation by the end user. The pre-sealed package prevents composition loss or degradation until release. For example, from packaging until release, throughout storage, shipping, etc. it is impervious to humidity, light, and mixing with foreign particles.

The invention removes the need for the manufacturer to provide discrete weights of powder product per bottle. The single-use, pre-weighed, pre-packaged solid compressed form is directly dispersed into any bottle for use in any instrument. This replaces a powder that was provided in a bottle that was specific to the instrument intended for its end use. For example, requesting one hundred packages of 2-gram of phosphoramidite per bottle specific to a particular instrument is now replaced by single-use, pre-weighed, pre-packaged solid compressed form, i.e., a pill, pellet, or tablet. Using the invention, the appropriate number of pills, pellets, or tablets are in a form from which the end user dispenses the appropriate number each time the product is used, allowing reuse of the bottle on a specific instrument.

The single-use, pre-weighed, pre-packaged solid compressed form is prepared using commercially available presses. Examples of presses for use include Minipress (SMI Incorporated, Lebanon N.J.), stokes model pill presses (Compression Components & Service, Warminster Pa.), and Pro-Line tablet presses (Korsch, Germany).

In one embodiment, all or part of the surface of a solid composition is coated sufficient to prevent or retard penetration of other solids, liquids, or gases (e.g., water vapor) into the solid composition. In one embodiment, the surface of a solid composition is uncoated. In one embodiment, the solid composition is packaged to prevent or retard oxygen penetration into the solid composition. In embodiments, the packaging or container may be glass, e.g., a glass container, plastic, e.g., a plastic bag, a plastic container, a non-resealable blister pack, etc. In one embodiment, the solid composition is maintained in an anhydrous or substantially anhydrous state until release by the user.

The shelf-life of the composition thus sealed may conservatively range from 1 year, 3 years, 5 years, etc. depending upon storage conditions.

Percentages are expressed as w/w unless otherwise stated. Ranges are inclusive unless otherwise stated.

The desired storage temperature may range from about −20° C. to about 25° C. Phosphoramidite purity ranges from about 85% purity to about 100% purity. In one embodiment, purity is about 98%.

The phosphoramidite is generally anhydrous; the concentration of water in the composition ranges from 0.0% to 0.5%.

In one embodiment, the density of a solid form of the composition, i.e., pellet, pill, or tablet ranges from about 0.1 g/cm³ to about 10 g/cm³, or from about 0.2 g/cm³ to about 9 g/cm³, or from about 0.5 g/cm³ to about 5 g/cm³, or from about 0.8 g/cm³ to about 1.3 g/cm³, or about 1.1 g/cm³.

In one embodiment, the ratio of surface area to weight of a solid composition ranges from about 0.1 cm²/g to about 10 cm²/g, or from about 0.3 cm²/g to about 10 cm²/g, or from about 0.5 cm²/g to about 10 cm²/g, or from about 0.7 cm²/g to about 10 cm²/g, or from about 0.9 cm²/g to about 10 cm²/g, or from about 2 cm²/g to about 10 cm²/g, or from about 3 cm²/g to about 4 cm²/g, or about 3.6 cm²/g.

In one embodiment, the dissolution rate of a solid composition is about 1 g/min to about 10 g/min. The dissolution rate is also known to the person of ordinary skill in the art according to the Noyes Whitney equation, e.g., dW/dt=DA(Cₛ−C)/L

where dW/dt is the rate of dissolution, A is the surface area of the solid, C is the concentration of the solid in the bulk dissolution medium, Cₛ is the concentration of the solid in the diffusion layer surrounding the solid, D is the diffusion coefficient, and L is the diffusion layer thickness. In one embodiment, the rate of dissolution was about 0.2 gram in about one minute.

In one embodiment, the composition also comprises an effervescent composition that on contact with liquid, e.g., water, produces a carbon dioxide gas release. The resulting carbon dioxide release accelerates the distribution and/or dissolution of the composition into a liquid. Such effervescent compositions are known to the person of ordinary skill in the art and include, but are not limited to, acid-base compositions, e.g., a sodium bicarbonate/ascorbic acid composition. The acid and base are generally provided in the composition in anhydrous form. In one embodiment, the composition comprises a pH stabilizer and/or pH buffer.

In one embodiment, the solid is contained in or within a container. As previously described, the container may be, e.g., a closable bottle, a sealed blister packaging container, a sachet, a bag, or any other suitable container known to a person of ordinary skill in the art. In one embodiment, the container may contain a desiccant to retard or prevent moisture, and thus maintains the composition in an unchanged form, prolonging its effective shelf-life. Suitable desiccants include, but are not limited to, anhydrous silica gel, anhydrous calcium carbonate, anhydrous sodium carbonate, anhydrous copper sulfate, etc. The desiccant may be stored in an air-penetrable secondary container, e.g., a closed breathable sachet.

In one embodiment, the container retards or prevents exposure to light. In one embodiment, e.g., the container may be light retardant, or may be fashioned and/or contain a means to retard or prevent exposure of its contents to ultraviolet light, generally wavelengths ranging from 10 nm to 400 nm.

In one embodiment, the container may be fashioned or contain a means to retard or prevent exposure to oxygen, e.g., an oxygen barrier.

In one embodiment, a quantity of a phosphoramidite is provided to a mold or press, and the mold or press is compressed at a pressure ranging from about 200 pounds per square inch to about 20000 pounds per square inch, or from about 1000 pounds per square inch to about 5000 pounds per square inch. In one embodiment, the temperature of the mold and the composition provided to the mold are controlled such that there is no substantial temperature increase of the composition during compression. The loaded composition may be cooled before compression. In one embodiment, compression is effected in a substantially anhydrous atmosphere and/or an inert atmosphere.

In one embodiment, a kit includes the composition and a reactant. Reactants include those substrates that, in solution with the phosphoramidite, would react to form a reactant-phosphoramidite adduct. In one embodiment, the kit comprises a device comprising two closed compartments that may be simultaneously or sequentially opened. One closed compartment contains the composition in solid form, and the other closed compartment contains the reactant. The two compartments may be opened and added to a liquid to result in production of the reactant-phosphoramidite adduct. As an example, the kit may be a two-well blister pack that, when opened, allows the user to quickly and efficiently deposit the pre-dosed composition and the reactant

In one embodiment, a kit contains the solid and is adapted to be used in an automated process to provide phosphoramidite dispersions or solutions. The kit may contain, e.g., a bottle with a neck adapted to be placed in register with an inlet port to a device to result in a solution, maintaining the composition in an anhydrous state

The following non-limiting examples illustrate various embodiments.

### EXAMPLE 1

A 2 gram sample of a 99.9% pure 5 aminohexyl linker phosphoramidite, Thermo Fischer product number 27-0035, is loaded into a minipress (SMI Inc., Lebanon N.J.) and compressed for 0.3 minutes at 12000 pounds per square inch to provide a 5 mm×5 mm×2 mm tablet. The tablet is extruded from the device.

### EXAMPLE 2

Two-hundred 2-gram tablets as provided in EXAMPLE 1 are loaded into a screw-top UV-light inhibiting, amber glass bottle. A 5-gram sachet of anhydrous silica gel is placed into the bottle. The bottle is sealed with a plastics film and a screw top screwed on. Teflon tape is used to seal the gap between screw-top and glass bottle.

### EXAMPLE 3

Two hundred 2-gram tablets provided in EXAMPLE 1 are loaded into the wells of 2 10×10 unsealed blister packaging sheets. Each well contains one tablet. A foil sheet is laid over the wells, enclosing each well. The operation takes place in a nitrogen atmosphere.

### EXAMPLE 4

About 0.2 grams of phosphoramidite were loaded into a hand press and compressed to provide a tablet that had a density of about 1.1 g/cm³ and a surface area/mass ratio of about 3.6 cm²/g. The tablet was extruded from the device.

The embodiments shown and described in the specification are only specific embodiments of inventors who are skilled in the art and are not limiting in any way. Therefore, various changes, modifications, or alterations to those embodiments may be made without departing from the spirit of the invention in the scope of the following claims.

What is claimed is:

1. A formulation comprising phosphoramidite formulated as a powder compressed into a single-use, self-contained solid in the absence of a glass vial.

2. The formulation of claim 1 containing at most 1% water.

3. The formulation of claim 1 being substantially anhydrous.

4. The formulation of claim 1 wherein the solid is selected from the group consisting of a tablet, a pill, a pellet, and combinations thereof.

5. The formulation of claim 1 having a density from about 0.1 g/cm³ to about 10 g/cm³.

6. The formulation of claim 1 having a ratio of surface area to weight from about 0.1 cm²/g to about 10 cm²/g.

7. The formulation of claim 1 wherein the phosphoramidite powder has an average particle size from about 1 μm to about 1000 μm.

8. The formulation of claim 1 wherein the phosphoramidite powder has a particle size of about 20 μm.

9. The formulation of claim 1 packaged in plastic.

10. The formulation of claim 1 packaged with a desiccant.

11. The formulation of claim 1 contained in a light-retardant container or containing light retardant means.

12. The formulation of claim 1 wherein the solid has a water-retardant or water-impervious coating.

13. The formulation of claim 1 where phosphoramidite purity ranges from about 85% to about 100%.

14. A kit comprising at least one single-use, pre-weighed, pre-packaged solid compressed phosphoramidite, and instructions for use.

15. The kit of claim 14 containing a plurality of single-use, pre-weighed, pre-packaged solid compressed forms of phosphoramidites.

16. The kit of claim 14 where the phosphoramidite is generally anhydrous.

17. The kit of claim 14 where the instructions provide use of the solid compressed forms of phosphoramidite in an instrument.

18. Phosphoramidite formulated as a powder compressed into multiple solid forms for a single use or multiple uses.

19. The phosphoramidite of claim 18 wherein the multiple solid forms include tablets, pellets, pills, and combinations thereof.

20. The phosphoramidite of claim 18 wherein the multiple solid forms are for a full single use.

21. The phosphoramidite of claim 18 wherein the multiple solid forms are for a fraction of a single use.
